(19) United States
(12) Patent Application Publication
(10) Pub. No.: US 2022/0339787 A1
(43) Pub. Date: Oct. 27, 2022

(54) CARRYING OUT AN APPLICATION USING AT LEAST ONE ROBOT

(71) Applicant: KUKA Deutschland GmbH, Augsburg (DE)

(72) Inventors: Manuel Kaspar, Königsbrunn (DE); Pierre Venet, Augsburg (DE); Jonas Schwinn, Augsburg (DE)

(21) Appl. No.: 17/616,757

(22) PCT Filed: Jun. 29, 2020
(86) PCT No.: PCT/EP2020/068241

§ 371 Date: Dec. 6, 2021

(30) Foreign Application Priority Data
Jul. 1, 2019 (DE) 10 2019 209 616.6
Jun. 3, 2020 (DE) 10 2020 206 924.7

(51) Int. Cl. B25J 9/16

(52) U.S. Cl. CPC B25J 9/1664

(57) ABSTRACT

A method for carrying out an application using at least one robot includes, repeatedly ascertaining a stochastic value of at least one robot parameter and/or at least one environmental model parameter; and carrying out a simulation of the application on the basis of the ascertained stochastic value, training at least one control agent and/or at least one classification agent using the simulations by machine learning, and carrying out the application using the robot. The method may further include configuring a controller of the robot, by means of which the application is carried out wholly or in part, based on the trained control agent, and/or classifying the application using the trained classification agent.

### CROSS-REFERENCE TO RELATED APPLICATIONS

This application is a national phase application under 35 U.S.C. § 371 of International Patent Application No. PCT/EP2020/068241, filed Jun. 29, 2020 (pending), which claims the benefit of priority to German Patent Application No. DE 10 2019 209 616.6, filed Jul. 1, 2019 amd German Patent Application No. DE 10 2020 206 924.7, filed Jun. 3, 2020, the disclosures of which are incorporated by reference herein in their entirety.

### TECHNICAL FIELD

The present invention relates in particular to a method for carrying out an application using at least one robot, to a method for configuring a controller of a robot for carrying out an application or a specified task, to a method for training at least one classification agent for classifying a robot application, to a method for carrying out a specified task using at least one robot with a correspondingly configured controller as well as to a system and a computer program product for carrying out at least one of these methods.

### BACKGROUND

In order to carry out applications or specified tasks, controllers of robots must be configured accordingly, conventionally by manually creating robot programs or the like.

### SUMMARY

An object of one embodiment of the present invention is to improve carrying out an application or a specified task using at least one robot. An object of one embodiment of the present invention is to improve configuring a controller of the robot for carrying out the application or the specified task. An object of one embodiment of the present invention is to improve classifying a robot application. An object of one embodiment of the present invention is to improve a controller of a robot by means of which an application is carried out.

According to one embodiment of the present invention, a method for
Configuring a controller of a robot for carrying out an application using the robot (robot application);
Training at least one classification (AI) agent to classify a robot application; and/or
Carrying out a or the (robot) application using at least one/the robot

comprises the steps, repeated multiple times, and cyclically in one embodiment:
Ascertaining a one- or multi-dimensional stochastic value of at least one one- or multi-dimensional robot parameter and/or at least one one- or multi-dimensional environmental model parameter, in one embodiment on the basis of a specified stochastic parameter model and/or using at least one random generator; and
Carrying out a simulation, in one embodiment a multi-stage simulation, of the application on the basis of the ascertained stochastic value.

The stochastic value for a simulation can be ascertained before the simulation is carried out and then used in the simulation. Likewise, a plurality of stochastic values of the robot parameter and/or the environmental model parameter can also be ascertained in advance and then one of these stochastic values can be used for or in one of the simulations.

According to one embodiment of the present invention, the method comprises the step:
Training
   at least one control (AI) agent and/or
   at least one classification (AI) agent

using the simulations by means of machine learning, in one embodiment
Training a first control (AI) agent and/or a first classification (AI) agent by means of first stages of the simulations, and
Training at least one additional control (AI) agent and/or at least one additional classification (AI) agent by means of additional stages of the simulations.

According to one embodiment of the present invention, the method comprises the step:
Carrying out of the (real) application using the robot once or multiple times.

It is also possible to train a plurality of control (AI) agents using a plurality of (simulation) stages and only one classification (AI) agent using the simulations or a plurality of classification (AI) agents using a plurality of (simulation) stages and only one control (AI) using the simulations.

In one embodiment, the robot or environmental model parameter (value) is thus randomized or the simulations are carried out with randomized robot or environmental model parameter(s) (values) and the agent or agents are trained or machine learned using these simulations.

As a result, machine learning can be improved in one embodiment and made more robust and/or faster in one embodiment. Additionally or alternatively, an agent trained in this way or on the basis of randomized robot or environmental model parameter(s) (values) can thereby improve carrying out the (real) application using the robot, in particular the controller of the robot and/or classification of the application, in particular act (more) robustly and/or (more) flexibly.

When an agent is referred to herein, this in each case comprises in particular an A(rtificial) I(ntelligence) agent, in particular a control (AI) agent or a classification (AI) agent.

In one embodiment, ascertaining a stochastic value comprises generating the value, in particular numerically and/or physically, and may in particular be generating the value.

The stochastic values on the basis of which the simulations are carried out are, in particular will be, ascertained, in particular generated, in one embodiment using at least one random generator, in particular a pseudo-random number generator, and/or are stochastically or randomly distributed values, in one embodiment random numbers, in particular pseudo-random numbers, which in one embodiment are determined by the specified stochastic parameter model or which satisfy this model.

In one embodiment, the stochastic parameter model comprises one or more stochastic parameters, in particular minimum, maximum, expected and/or mean value(s), variance(s), standard deviation(s), measure(s) of dispersion or the like, and/or a probability distribution, for example a Gaussian or normal distribution, a uniform distribution or the like.

For example, a user and/or user input support or a software assistant can specify a minimum and maximum value as well as a uniform distribution and thus a stochastic parameter model for a robot or environmental model parameter, whereby corresponding stochastic(ally distributed) values are then generated using a (pseudo-)random number generator and ascertained in this way on the basis of this specified stochastic parameter model and using this (pseudo-)random number generator. Likewise, the user and/or user input support can, for example, specify a specific Gaussian distribution and thus a different stochastic parameter model, whereby corresponding stochastic(ally distributed) values are then generated again using a (pseudo-)random number generator and are ascertained in this way on the basis of this other specified stochastic parameter model and using this (pseudo-) random number generator.

Thus, in one embodiment, the ascertained stochastic values are (also) (co-)determined by the specified stochastic parameter model, for example limited by minimum and/or maximum value(s), scattered around an expected or mean value by variance(s) or the like.

A simulation is understood to mean, in particular, a simulation run or a numerical simulation of the application or its temporal sequence.

In one embodiment, a multi-stage simulation comprises two or more successive time and/or functional portions or stages of the application that are contiguous in one embodiment, for example the robot-assisted joining of a first gearwheel (first stage) and the subsequent robot-assisted joining of an additional gearwheel (additional stage) or the like.

In one embodiment, a first control agent is trained by means of first stages or portions of the simulations and at least one additional control agent is trained by means of additional stages or portions of the simulations and/or a first classification agent is trained by means of the same or different first stages or portions of the simulations and at least one additional classification agent is trained by means of additional stages or portions of the simulations: in the above example, a first (control or classification) agent for joining the first gearwheel by means of the first simulation stages or simulations of joining the first gearwheel and an additional (control or classification) agent for joining the additional gearwheel by means of the additional simulation stages or simulations of the joining of the additional gearwheel.

In one embodiment, an initial state for a later simulation stage is ascertained or specified on the basis of a final state or result of a previous simulation stage, wherein in one embodiment, this initial state can additionally be varied, in particular randomized, in particular on the basis of user input or a user specification. In the above example, for example, a position of the first gearwheel after its simulated joining can be used as a starting value in the additional simulation stage and, if necessary, changed and/or randomized by a user.

In this way, a multi-stage application can be carried out particularly advantageously in one embodiment.

According to one embodiment of the present invention, the method comprises the step:
Configuring a controller of the robot to carry out the application, in particular a controller of the robot by means of which the application is carried out, on the basis of the/one or more trained control agent(s).

Thus, according to one aspect of the present invention, the simulations with stochastic or randomized values are used to machine learn a controller of the robot for carrying out the (real) application using the robot or to train one or more agents for this purpose.

As a result, in one embodiment, carrying out the (real) application can be improved using the robot, in particular the application can be carried out (more) robustly and/or (more) flexibly.

In one embodiment, a controller of the robot, by means of which only part of the application is to be carried out, is configured on the basis of the trained control agent, in particular on the basis of the trained control agents.

In particular, the application can comprise one or more portions that are (should) be carried out with a (different) controller of the robot that is or is not configured on the basis of the trained control agent(s), as well as one or more portions that are (should) be carried out with a controller of the robot that is configured on the basis of the trained control agent(s). A controller within the meaning of the present invention can in particular comprise, in particular be, a control device and/or a computer program, in particular a (computer) program module or part.

In particular, it can be useful to configure a (different) controller using geometric or dynamic path planning, teaching or the like for transfer portions in which the robot moves a load freely, and for contact, in particular gripping and/or joining sections, in which there is environmental contact of the robot, in particular in which the robot grips or joins a load, to configure a controller on the basis of the trained agent(s).

In addition or as an alternative to this aspect, the method according to one embodiment of the present invention comprises the step:
Classifying the application using the/one or more trained classification agent(s).

Thus, according to one aspect of the present invention, the simulations with stochastic or randomized values are used to machine learn a classification of the (real) application or to train one or more classification agents for this purpose.

As a result, in one embodiment, carrying out the (real) application can be improved using the robot, in particular the application can be monitored (more) robustly and/or (more) flexibly.

In one embodiment, the/one or more classification agent(s) comprise(s) machine-learned anomaly detection. Additionally or alternatively, in one embodiment the/one or more classification agent(s) comprise(s) machine-learned error detection.

In one embodiment, anomaly detection comprises a classification of the application(s) carried out into normal and abnormal applications. In one embodiment, anomaly detection is machine learned, in particular only on the basis of simulated applications labeled as normal, and/or anomaly detection classifies an application as abnormal if it deviates (to too great an extent) from the simulated applications labeled as normal.

If, for example, an obstacle not taken into account in the simulations blocks the real application from being carried out using the robot, the force and/or posture data in particular of the robot deviate significantly from the curves in simulated applications labeled as normal, and the agent accordingly classifies this real application as abnormal.

In one embodiment, error detection comprises a classification of the application(s) carried out into error-free and erroneous application(s), in one embodiment into different error classes. It is or will be machine learned in an embodiment on the basis of simulated applications labeled as error-free and simulated applications labeled as erroneous or corresponding to a corresponding error class and/or an application will be classified into a (corresponding) error class if it sufficiently, in particular most closely, resembles the correspondingly labeled simulated applications.

For example, in the above example, joining the first gearwheel using the robot, in particular on the basis of force and/or posture data of the robot, can be classified as error-free, as attached, but not sufficiently deep and/or clamped, or as not joined, if the force or pose data sufficiently resemble the curves of appropriately labeled simulated applications and the agent classifies this real application into the corresponding error class.

The invention can be used with particular advantage for such classifications of robot applications, since these can (only) be machine learned with difficulty using (real) applications carried out with the robot.

In one embodiment, the/one or more control agent(s) and/or the/one or more classification agent(s) each comprise at least one artificial neural network; in one embodiment, the controller of the robot is configured on the basis of the structure and/or weightings of the trained network.

In this way, a particularly advantageous controller can be implemented in one embodiment and/or the controller can be configured in a particularly advantageous manner.

In one embodiment, the/one or more control agent(s) and/or the/one or more classification agent(s) is/are trained by means of reinforcement learning, in particular deep reinforcement learning.

This is particularly suitable for configuring a controller of the robot and for classifying, in particular anomaly and/or error detection, of the application.

In one embodiment, the/one or more control agent(s) and/or the/one or more classification agent(s) is/are trained, in particular additionally, using the robot, in one embodiment on the basis of one or more (real) applications carried out using the robot.

As a result, in one embodiment, the corresponding agent can be used particularly advantageously when carrying out the real application using the robot and/or machine learning can be (further) improved.

In one embodiment, the/one or more control agent(s) and/or the/one or more classification agent(s) is/are (each) trained on the basis of at least one state variable that is not measured when the application is carried out and which in one embodiment cannot be measured.

This is based, in particular, on the knowledge or idea that state variables are also calculable in the simulations, in particular are calculated, which state variables are not measured when the application is carried out, and possibly cannot be measured with the existing environment or configuration, in particular measuring equipment, and that such state variables, which occur or are calculable anyway, in particular are calculated, in particular in simulations for (the purpose of) configuring the controller, can (also) be used particularly advantageously for training or machine learning.

In the above example, it may be the case that the distance between the (first or additional) gearwheel and a stop cannot be measured, for example because there is no corresponding sensor or the space between the gearwheel and the stop is not accessible. In the case of a simulation of the joining, however, this distance can be calculated and then used as a state variable for training, in particular in a quality criterion.

In one embodiment, a quality criterion used when training the/one or more control agent(s) and/or classification agent(s), in particular a quality or cost function, is ascertained or dependent on the basis of at least one state variable that is not measured when the application is carried out and which in one embodiment with the existing configuration or environment cannot be measured.

As a result, machine learning can be improved in one embodiment and made more robust and/or faster in one embodiment.

In addition or as an alternative to the idea of using state variables that are not measured when the application is carried out but are calculated in the simulations for training the/one or more agent(s), one embodiment of the present invention is based on the knowledge or idea that simulations which are carried out (anyway) or used to train at least one control agent, on the basis of which the controller of the robot with which the (real) application is or should be carried out is configured, are or should also be used to train one or more classification agents, by means of which the (real) application that is carried out using the robot is or should be classified.

Accordingly, according to one embodiment of the present invention, the method comprises both the step:
Configuring a controller of the robot to carry out the application, in particular a controller of the robot by means of which the application is carried out wholly or in part, on the basis of the/one or more trained control agent(s);

As well as the step:
Training the/one or more classification agent(s), in particular classifying of the application using the/one or more trained classification agent(s),

wherein in one embodiment, control and classification agents are or have been trained using the same simulations, wherein in a further development, the/one or more classification agent(s) are trained using simulations that have already been carried out, by means of which the/one or more control agent(s) have been trained beforehand, and/or synchronously using current simulations, by means of which the/one or more control agent(s) are currently being trained.

In other words, one embodiment of the invention uses simulations on the basis of which, in particular by means of reinforcement learning, the controller is configured or by means of which the/one or more control agent(s) is/are trained, in one embodiment has/have been trained, or are also used to train at least one machine-learned classification or the/one or more classification agent(s).

In one embodiment, for this purpose, data, in particular state variables, in one embodiment (temporal) state variable curves, in particular trajectories, of the application, in one embodiment of the robot, which are or have been calculated in simulations, in one embodiment simulations by means of which the/one or more control agent(s) is/are or has/have been trained, are stored and the/one or more classification agent(s) is/are trained using these stored data, in one embodiment following these simulations and/or during of these simulations.

In one embodiment, these data comprise poses of one or more robot-fixed references, in particular an end effector, TCPs, robot-guided tool or piece or the like, joint or axis divisions of the robot, internal and/or external forces on the robot, in particular joint and/or driving forces, frictional forces, contact forces or the like, current variables, in particular voltages and/or currents in the drives of the robot, contouring errors of the robot and/or temporal derivatives of such poses, positions, forces, current variables or contouring errors, in particular velocities and/or accelerations of one or more robot-fixed references, axes or joints, drives, changes in such forces over time, current variables or contouring errors or the like. Contouring errors can in particular comprise force, position and/or velocity errors.

In one embodiment, the simulations that have already been carried out in one embodiment become those simulations by means of which the/one or more control agent(s) is/are or has/have been trained, in particular, on the basis of the stored data, those simulations or data are selected in which a quality criterion is met and used to train anomaly detection, or those simulations or data are sorted into different error classes on the basis of a quality criterion and used to train error detection.

If, for example, traj_i denotes the data of a simulation i, traj={traj_i} denotes the amount of all data stored during the simulation, in one embodiment for machine learning anomaly detection, the data {traj_success} of those simulations in which a successful course of the application was simulated or resulted, or the data {traj_failure_k1}, {traj_failure_k2}, . . . of those simulations in which an error k1, k2, . . . was simulated or resulted, are selected and then anomaly detection using {traj_success} or error detection using {{traj_success}, {traj_failure_k1}, {traj_failure_k2}, . . . } is machine learned.

As a result, the machine-learned classification can in each case be improved in one embodiment, in particular learned more quickly and/or classified more precisely, more robustly and/or more reliably.

In one embodiment, the/one or more agent(s), in particular anomaly detection and/or error detection, classifies the application on the basis of at least one time segment, in one embodiment a moving, in particular migrating, time segment. In one embodiment, in addition or as an alternative to an evaluation of the complete application, a continuous and/or serial evaluation is carried out and the agent classifies the application on the basis of this continuous or serial evaluation. Recurrent networks, Markov models or autoregressive networks are particularly suitable for this purpose.

As a result, machine learning can be improved in one embodiment and made more efficient and/or faster in one embodiment.

In one embodiment, the/one or more agent(s), in particular anomaly detection and/or error detection, classifies the application while the application is being carried out.

In one embodiment, this allows a reaction to the result of the classification. Correspondingly, in one embodiment, the application that is being carried out/has just been carried out is changed if necessary on the basis of the classification; in one embodiment a corresponding signal is output when an anomaly and/or error is detected and/or a motion of the robot is modified and/or a workpiece that is handled, in particular transported and/or processed, during the application is sorted out or reworked.

In one embodiment, the/one or more agent(s), in particular anomaly detection and/or error detection, classifies the application after the application has been carried out.

In this way, the application can be classified more precisely in one embodiment.

In one embodiment, the robot parameter comprises a one- or multi-dimensional start pose, one or more one- or multi-dimensional intermediate poses and/or a one- or multi-dimensional target pose of the application, in particular of the robot. Correspondingly, in one embodiment, the simulations of the application are carried out on the basis of stochastic (distributed or generated) start, intermediate and/or target poses. As a result, inaccuracies as a result of previous processes, deviations when running or the like can be taken into account in one embodiment and machine learning or the trained agent(s) can thereby be improved, in particular made (more) robust and/or (more) flexible.

In one embodiment, in particular before carrying out the simulation, it is checked whether (the stochastic value for) the start pose, intermediate pose(s) and/or target pose can be achieved with the robot, in particular on the basis of a kinematic model of the robot. If the pose or the corresponding stochastic value of the robot parameter cannot be reached, in one embodiment the value is ascertained again or until (it is determined that) the pose or the value can be reached with the robot, and then this value is used as the ascertained value when carrying out the simulation of the application. As a result, machine learning can be improved in one embodiment and made more efficient and/or faster in one embodiment.

A pose within the meaning of the present invention can in particular comprise, in particular be, a one-, two- or three-dimensional position and/or one-, two- or three-dimensional orientation.

Additionally or alternatively, in one embodiment the robot parameter comprises a one- or multi-dimensional force parameter of a robot-internal force, in particular at least one axis and/or at least one end effector rigidity and/or damping. As a result, wear and tear or tolerances between robots of the same model or the like can be taken into account in one embodiment and machine learning or the trained agent(s) can thereby be improved, in particular made (more) robust and/or (more) flexible.

Additionally or alternatively, in one embodiment the robot parameter comprises a one- or multi-dimensional force parameter of an external force that acts on the robot at least, in one embodiment only, temporarily, in particular a (stochastic) disturbance or disturbance force, in particular an external force as a result of environmental contact or the like. As a result, real process conditions or random faults can be taken into account in one embodiment and machine learning or the trained agent(s) can thereby be improved, in particular made (more) robust and/or (more) flexible.

A force in the sense of the present invention can in particular comprise, in particular be, an antiparallel force pair or torque. A force parameter can in particular comprise a force, but also a rigidity, a damping and/or a coefficient of friction or the like.

Additionally or alternatively, the robot parameter in one embodiment comprises a one- or multi-dimensional kinematic, in one embodiment a dynamic, robot structure parameter, in particular a one- or multi-dimensional dimension and/or a weight and/or a one- or multi-dimensional moment of inertia of the robot or individual structural links or structural links groups, or the like. As a result, tolerances between robots of the same model or the like can be taken into account in one embodiment and machine learning or the trained agent(s) can thereby be improved, in particular made (more) robust and/or (more) flexible.

Additionally or alternatively, the environmental model parameter in one embodiment comprises a one- or multi-dimensional kinematic, in one embodiment a dynamic, environmental, in one embodiment load structure parameter, in particular a one- or multi-dimensional pose and/or dimension and/or a weight and/or a moment of inertia of an environmental structure, in particular a load structure, in particular a tool and/or workpiece or the like used in the application. As a result, tolerances between tools or workpieces of the same model, inaccuracies as a result of previous processes or the like can be taken into account in one embodiment and machine learning or the trained agent(s) can thereby be improved, in particular made (more) robust and/or (more) flexible.

Additionally or alternatively, in one embodiment the robot parameters and/or the environmental model parameters are ascertained by means of robot-supported parameter identification, for example minimum, maximum and/or mean value(s) of or for the stochastic parameter model. In one embodiment, this can improve the correspondence with the real application and machine learning or the trained agent(s) can thereby be improved, in particular made (more) robust and/or (more) flexible.

In one embodiment, the predefined stochastic parameter model is, in particular, specified on the basis of user input and/or application-specifically, in one embodiment selected from a plurality of different parameter models made available.

In one embodiment, a user can first select one of a plurality of probability distributions, for example a Gaussian distribution, a uniform distribution or another probability distribution, and specify minimum and maximum values or the like for this purpose. Likewise, for certain joining applications, for example a probability distribution, for example a uniform distribution for certain gripping applications, a different probability distribution, for example a Gaussian distribution or the like, can be selected and application-specific minimum and maximum values or the like can be specified for this purpose. Mixed forms are also possible, in particular an application-specific preselection or default value assignment and an input option for the user to change these.

Additionally or alternatively, in one embodiment the robot parameter and/or the environmental model parameter is/are in particular specified on the basis of user input and/or application-specifically, in one embodiment they are selected from a plurality of different parameters made available.

For example, for inserting a robot-guided workpiece into a recess in a flat surface, a two-dimensional position within the surface and a one-dimensional orientation or angular position and orientation around a surface normal can be specified or selected as the target pose, whereas for drilling with a robot-guided drill in a flat surface, a one-dimensional distance to the surface along the drill axis can be specified or selected as the target or intermediate pose.

In one embodiment, the stochastic parameter model and/or the robot parameter and/or the environmental model parameter is visualized in an image, in particular a virtual image, of the application by a marked region, in one embodiment by corresponding geometric spaces, in particular bodies such as cuboids, spheres, cones, cylinders or the like, or, in particular, planar or environment-adapted surfaces.

In the above example, the region within the surface in which the target position can (stochastically) be located can be visualized in an image of the application, for example by a corresponding circular surface, the possible orientations or angular positions and orientations around the surface normal, for example, by two appropriately rotated cuboids or workpiece avatars in the respective maximum possible deflections.

In one embodiment, a probability distribution of the stochastic parameter model is visualized by a different coloring, in one embodiment different (color) brightness, of the marked region, wherein the respective coloration or brightness (level) depends on the probability that the robot or environmental model parameter comprises the corresponding value.

In the above example, the region within the surface in which the target position can (stochastically) be located can be visualized in an image of the application, for example, by a corresponding circular surface, wherein regions of the circular surface in which the target position is more likely to be, for example are colored darker or a first region of the circular surface in which the target position lies with a first probability, for example is colored with a first color and/or brightness, and at least one other region of the circular surface in which the target position lies with a different probability, is colored with a different color and/or brightness.

As a result, in one embodiment, in particular in combination, a particularly suitable parameter model or particularly suitable parameters can be selected, in particular the velocity and/or error tolerance of the input can be improved. User input support by a software assistant described elsewhere is particularly advantageous both for user input for specifying, in particular selecting, the stochastic parameter model and user input for specifying, in particular selecting, the robot parameter and/or environmental model parameter.

In one embodiment, the configured controller of the robot and/or machine-learned anomaly detection and/or error detection is tested using at least one additional simulation, in particular on the basis of an automated specification or user specification of a value of at least one robot parameter and/or at least one environmental model parameter.

For example, the user can change the pose of a workpiece for the test simulation and then use the test simulation to check whether or how well the configured controller or anomaly or error detection works or performs (for this purpose). Likewise, a test script can automatically carry out further simulation with the trained control agent(s) or trained anomaly and/or error detection and vary the values of at least one robot parameter and/or at least one environmental model parameter.

Additionally or alternatively, in one embodiment, the configured controller of the robot and/or machine-learned anomaly detection and/or error detection, in particular by means of machine learning, in particular reinforcement learning, are further trained by means of the robot, in particular on the basis of applications carried out using the robot.

As a result, a controller which is particularly advantageous in practice can be implemented in one embodiment, in particular in combination.

In one embodiment, the stochastic parameter model is, in particular, specified by means of machine learning. In particular, a parameter model (AI) agent on the basis of previous applications carried out using the robot, which have been classified by means of a classification agent trained according to a method described herein and/or in which the controller of the robot by means of which these applications were carried out have been configured on the basis of a control agent trained according to a method described herein, on the basis of the results of the previous applications carried out and the stochastic parameter model used in training this classification or control agent, the stochastic parameter model is specified, which is then used in a method described herein to carry out simulations to train the at least one classification agent, by means of which a new application is then classified, and/or the at least one control agent, by means of which a controller is then configured to carry out a new application.

In this way, a particularly advantageous, in particular realistic, stochastic parameter model can be used, preselected in one embodiment, in particular by user input support or the software assistant. In addition or as an alternative to the earlier applications carried out using the robot, simulated applications can also be used as earlier applications for machine learning for specifying the stochastic parameter model.

In one embodiment, one or more steps of one of the methods described herein, in particular the specification, in particular selection, of the stochastic parameter model and/or the robot parameter and/or the environmental model parameter, comprise user input support by a software assistant, in particular a user interface guide, in particular a so-called wizard.

In one embodiment, the robot parameter and/or the environmental model parameter and/or the stochastic parameter model is preselected from a plurality of different parameters or parameter models made available, in particular application-specifically and/or by user input support or the software assistant.

As a result, in one embodiment, in particular in combination, a particularly suitable parameter model or particularly suitable parameters can be selected, in particular the velocity and/or error tolerance of the input can be improved.

Additionally or alternatively, one or more steps of one of the methods described herein are carried out in a cloud.

As a result, this method can advantageously be carried out in parallel and/or (more) quickly and/or in a distributed manner.

According to one embodiment of the present invention, a method for configuring a controller of a robot for carrying out a specified task comprises the following steps:
Recording at least one one- or multi-dimensional robot parameter and at least one one- or multi-dimensional environmental model parameter;
Training an (AI) agent using one or more simulations on the basis of this recorded robot parameter and this recorded environmental model parameter by means of machine learning on the basis of a specified cost function; and
Configuring the controller of the robot on the basis of the trained agent.

By training an agent by means of machine learning using one or more simulations, a controller of a robot for carrying out a specified task can be configured particularly advantageously in one embodiment.

In one embodiment, the robot comprises a stationary or mobile, in particular movable, base and/or a robot arm with at least three, in particular at least six, in one embodiment at least seven joints or (motion) axes, in one embodiment swivel joints or axes of rotation. The present invention is particularly suitable for such robots because of its kinematics, variability and/or complexity.

In one embodiment, the specified task comprises at least one motion of the robot, in particular at least one scheduled environmental contact of the robot, i.e. it can in particular comprise robot-assisted gripping and/or joining. The present invention is particularly suitable for such tasks because of its complexity.

In one embodiment, the robot parameter comprises
a one- or multi-dimensional kinematic, in particular dynamic, robot model parameter, in particular one or more center distances, masses, centers of gravity, inertia and/or rigidities; and/or
a one- or multi-dimensional kinematic, in particular dynamic, load model parameter, in particular one or more dimensions, masses, centers of mass and/or inertia; and/or
a current robot pose, in particular one or more current axis or joint positions; and/or
a current robot operating time.

Additionally or alternatively, in one embodiment the environmental model parameter comprises a one- or multi-dimensional CAD model parameter and/or, in particular current, robot positioning in the environmental model and/or is ascertained using at least one optical sensor, in particular a camera.

In one development, this optical sensor is guided, in particular held or carried, by a person, in another development by a robot, which in turn, in one embodiment for this purpose, follows a programmed or automatically determined path, in particular by means of collision avoidance, or is guided manually or by forces exerted manually on the robot.

In one embodiment, the agent comprises an artificial neural network. In a further development, the controller of the robot is then configured on the basis of the structure and/or weightings of the trained network, and this structure and/or these weightings are transferred in one embodiment to the controller of the robot. Additionally or alternatively, the agent is trained in one embodiment by means of reinforcement learning, preferably deep reinforcement learning.

In one embodiment, after it has been configured as described herein, the controller of the robot is further trained by means of machine learning, in particular reinforcement learning, preferably deep reinforcement learning, using the real robot.

In one embodiment, the robot parameter and/or environmental model parameter is, in particular, stored at least temporarily in an asset administration shell and/or in a data cloud.

According to one embodiment of the present invention, in a method for carrying out a specified task using at least one robot, a controller of the robot is, in particular will be, configured according to a method described herein. Correspondingly, in one embodiment, an inventive method can comprise a method described herein for configuring a controller of a robot for carrying out a specified task and the step of carrying out the specified task using the robot with the inventively configured controller.

According to one embodiment of the present invention, a system, in particular in terms of hardware and/or software, in particular in terms of programming, is configured to carry out one or more methods described herein. In one embodiment, the system comprises means for recording at least one robot parameter and at least one environmental model parameter, means for training an agent using at least one simulation on the basis of the recorded robot parameters and environmental model parameters by means of machine learning on the basis of a specified cost function, and means for configuring the controller of the robot on the basis of the trained agent.

In one embodiment, the system comprises:

Means for ascertaining, repeated multiple times, a stochastic value of at least one robot parameter and/or at least one environmental model parameter, in particular on the basis of a specified stochastic parameter model and/or using at least one random generator; and carrying out a simulation, in particular a multi-stage simulation, of the application on the basis of the ascertained stochastic value; and

Means for training at least one control agent and/or at least one classification agent using the simulations by means of machine learning, in particular training a first control agent and/or first classification agent by means of first stages of the simulations, and at least one additional control agent and/or additional classification agent by means of additional stages of the simulations.

Additionally or alternatively, in one embodiment, the system comprises means for configuring a controller of the robot on the basis of the trained control agent, in particular the trained control agents, for carrying out the application.

Additionally or alternatively, in one embodiment the system comprises means for classifying the application of the trained classification agent, in particular the trained classification agents.

Additionally or alternatively, in one embodiment the system comprises means for carrying out the application using the robot, wherein a controller of the robot by means of which the application is carried out wholly or in part is configured on the basis of the trained control agent, in particular the trained control agents, and/or the application is classified using the trained classification agent, in particular the trained classification agents.

In one embodiment, the system or its means comprises: machine-learned anomaly detection and/or machine-learned error detection and/or at least one artificial neural network; and/or means for training at least one control agent and/or at least one classification agent by means of reinforcement learning and/or using the robot; and/or

Means for classifying the application on the basis of at least one, in particular moving, time segment and/or while the application is carried out or after the application has been carried out by means of the at least one classification agent; and/or means for training the at least one control agent and/or the at least one classification agent on the basis of at least one state variable that is not measured when the application is carried out; and/or means for ascertaining the robot parameter and/or the environmental model parameter using robot-assisted parameter identification; and/or means for checking whether the starting pose, intermediate pose and/or target pose can be reached with the robot; and/or

Means for specifying the stochastic parameter model on the basis of the application and/or user input, in particular for selecting from a plurality of different parameter models made available; and/or means for visualizing the stochastic parameter model in an image of the application by a marked region; and/or

Means for specifying the robot parameter and/or the environmental model parameter on the basis of the application and/or user input, in particular for selecting from a plurality of different parameters made available; and/or means for visualizing the robot parameter and/or the environmental model parameter in an image of the application by a marked region; and/or means for testing the configured controller of the robot and/or machine-learned anomaly detection and/or error detection by means of at least one additional simulation, in particular on the basis of an automated value or user specification of a value of at least one robot parameter and/or at least one environmental model parameter; and/or

Means for further training the configured controller of the robot and/or machine-learned anomaly detection and/or error detection using the robot; and/or

Means for specifying the stochastic parameter model using machine learning; and/or

Means for user input support of at least one of the method steps by a software assistant, in particular a user interface guide; and/or

Means for carrying out at least one of the method steps in a cloud.

A means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state and/or other non-volatile media. The program may be designed in such a way that it embodies or is capable of carrying out one or more of the methods described herein wholly or in part, so that the processing unit is able to carry out the steps of such methods and thus, in particular, configure the controller or classify or carry out the application or operate or control the robot. In one embodiment, a computer program product may comprise, in particular, a non-volatile storage medium for storing a program or comprise a program stored thereon, an execution of this program prompting a system or a controller, in particular a computer, to carry out the method described herein or one or more steps thereof.

In one embodiment, one or more, in particular all, steps of the method are carried out completely or partially automatically, in particular by the system or its means.

In one embodiment, the system comprises the robot.

In one embodiment, a framework is created that allows motion or task learning to be implemented more efficiently using the reinforcement learning method. In one embodiment, parameters of the robot are queried simply and efficiently and/or the environmental model is recorded. In particular, in order to learn (more) efficiently and (more) quickly and/or not to block the real system, this is not carried out in one embodiment on the real system, but in a cloud simulation environment. This can advantageously allow a parallelization of the learning process and thereby an advantageous increase in velocity and, in particular, a more robust model (through randomization of parameters).

It should be emphasized again that the present invention, in particular
Configuring a controller of a robot for carrying out an application using the robot (robot application);
Training one or more classification (AI) agents to classify a robot application; and
Carrying out a or the (robot) application using at least one or the robot

or means configured for this purpose comprises, in particular, (also) configuring the controller without carrying out the application, training the classification (AI) agent(s) without carrying out the application, in particular training the classification (AI) agents together with configuring the controller, but without carrying out the application, carrying out the application with an already configured controller and/or trained classification (AI) agent(s), i.e. without configuring and/or without training the classification (AI) agent(s), as well as the combination of configuring and/or training with carrying out or means (respectively) configured for this purpose. Correspondingly, a feature of carrying out the application also comprises, in particular, that the configuration of the controller or training of the classification (AI) agent(s) is configured or carried out in such a way that this feature is then implemented by the trained classification (AI) agent(s) when the application is carried out with the configured controller.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system according to one embodiment of the present invention;

FIG. 2 schematically illustrates parts of the system of FIG. 1;

FIG. 3 is a flowchart of a method according to one embodiment of the present invention;

FIG. 4 is a flowchart of a method according to a further embodiment of the present invention; and

FIG. 5 is a schematic illustration of a visualization of a stochastic parameter model and a robot parameter.

### DETAILED DESCRIPTION

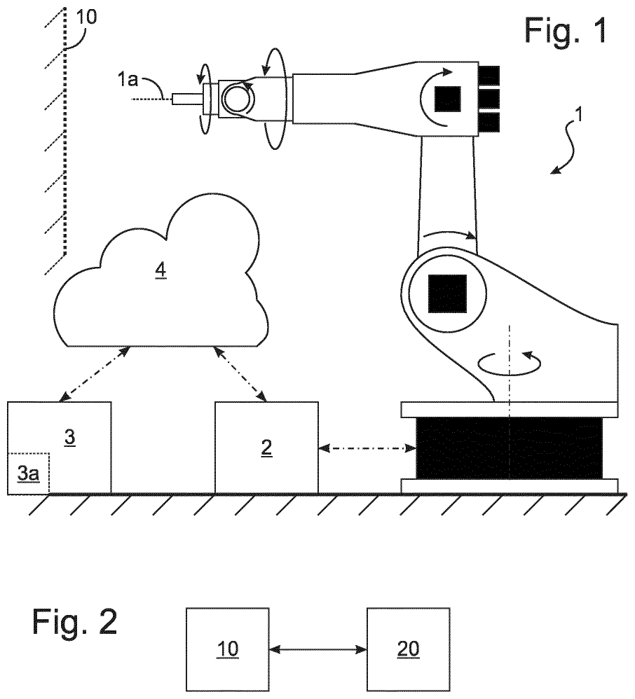

FIG. 1 shows a system according to one embodiment of the present invention with a robot 1, a (robot) controller 2 which communicates with the robot 1 and a cloud 4, as well as a data input/output and processing device, in particular a computer 3.

A wizard runs on its user interface, which wizard guides a user through one or more of the processes described below:

In a first step of a method according to one embodiment of the present invention (FIG. 3: S10), a robot parameter and a boot configuration are recorded. In order to carry out motion learning advantageously in a simulation environment, both the robot parameter and the environmental model parameter should be available as precisely as possible in the cloud simulation environment.

With the aid of a so-called asset administration shell (AAS), also called a digital twin, status and management data of the robot 1 are stored. An OPC UA information model is advantageously used for this purpose. In the asset administration shell of the robot, data such as the robot model, operating hours, current axis values (to ascertain a starting position), attached tools, etc. are available and are transferred to the cloud simulation environment. The simulation environment can configure the simulation with regard to the robot therefrom (CAD model, dynamic parameters, tools, current axis configuration, possibly changed dynamic parameters due to service life, etc.)

In a second step (FIG. 3: S20), the environmental model is recorded. In one embodiment, there are multiple options to choose from:
Transferring a fully modeled CAD model including transformation to the robot coordinate system;
Recording the environment by a 3D camera that is either manually-guided by a human or is mounted on the robot, which is
   is manually-guided or
   follows a defined and collision-free trajectory

In the case of manual guidance, it is also possible to record regions that are important for the task, for example a joining target, more precisely and from a short distance.

The environmental model generated in this way is now also transferred to the cloud simulation environment. A simple option here is to also store the data in the asset administration shell of the robot.

In one modification, the robot cell has an asset administration shell 10 (cf. FIG. 2), the environmental model and references to other involved asset administration shells. This means that the robot itself is interchangeable and as a whole, it has a more modular structure than if all the information is in the asset administration shell of the robot itself. The “cell manager” can then regulate the interaction with the subcomponents, the simulation environment 20 (cf. FIG. 2) and the execution of the learning process.

In a third step (FIG. 3: S30), the learning target is defined. A cost function is specified so that the reinforcement algorithm knows its target. In particular, it is possible in the guided wizard to specify the target, for example, by the user manually guiding the robot to the joining target and repeating this a few times in order to minimize errors.

A manual demonstration is also used in one embodiment, depending on the reinforcement learning algorithm, to initialize the algorithm or to carry out inverse reinforcement learning of the cost function. The trajectories of the demonstrations can also be stored in the asset administration shell.

In a fourth step (FIG. 3: S40), the task is learned in the cloud environment 4, preferably in parallel, using the deep reinforcement learning method.

The specific algorithm is advantageously
guided policy search;
soft Q-learning;
A3C

or the like.

In order to overcome the simulation-reality gap, the dynamic parameters are randomized in one embodiment. If a vision system is involved, a flexible vision model is learned by domain randomization.

A geometric path planner can plan non-contact path elements and, in the case of guided policy search, initialize the linear quadratic Gaussian controllers.

The result of the algorithm is the structure of the neural network and the trained weights of a neural network. As a modification, progressive nets can be used for later fine-tuning. The results of the simulation are sent back to the robot/edge controller.

In a fifth step (FIG. 3: S50), the model is downloaded to the robot or an edge controller.

The trained model can now be played back. In the asset administration shell of the simulation instance, parameters of the simulation and the learning algorithm can also be provided (e.g. learning rate, number of iterations, etc., which can later be used for fine-tuning). In particular, the ONNX exchange format, for example, can be used for exchanging the computation graph and the weights.

In an optional sixth step (FIG. 3: S60), the model is fine-tuned on the real system.

Depending on the quality of the simulation, the model is immediately ready-to-use or is further fine-tuned on the real system. In other words, the reinforcement learning algorithm is further trained on the real system, wherein initialization using the weights and other parameters of the reinforcement algorithm is advantageous.

In a seventh step (FIG. 3: S70), the learned task can now be carried out.

FIG. 4 shows a method according to a further embodiment of the present invention which can be carried out with the system of FIG. 1.

In one step S100, a random generator 3a (cf. FIG. 1) provided in this embodiment and therefore indicated by dashed lines is used to generate a stochastic value of a robot parameter and/or an environmental model parameter, for example a two-dimensional target position of a connector 1a guided by a robot in this embodiment in a surface 10 (cf. FIG. 1), on the basis of a specified stochastic parameter model, in the embodiment a Gaussian distribution specified by a user using the wizard.

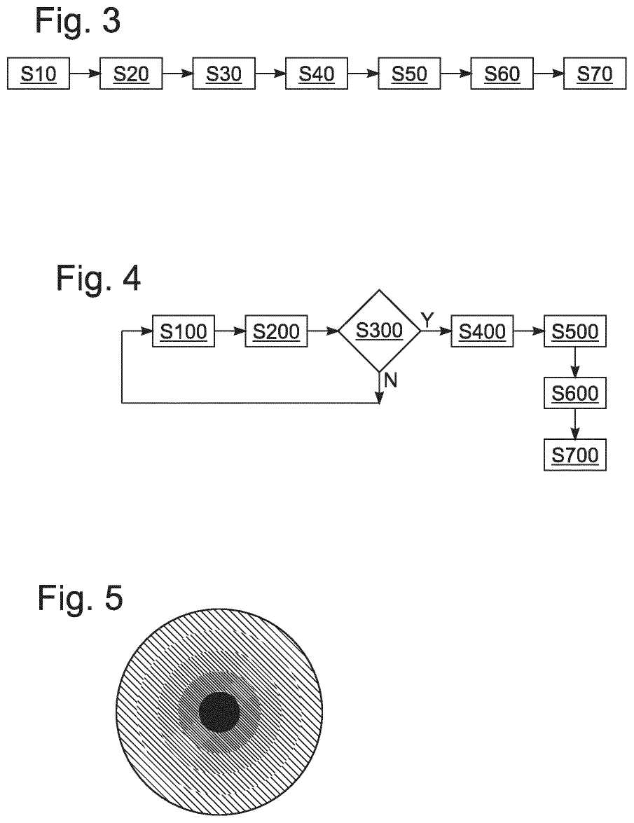

FIG. 5 shows by way of example how this robot parameter and this stochastic parameter model are visualized in an image of this joining application by a marked region in the form of a circle around the mean or expected value of the Gaussian distribution for the two-dimensional target position in the (image of the) surface. The edge of the circle visualizes a maximum value of a deviation from the mean or expected value and the different coloring indicated by different hatching, in one embodiment different (color) brightness, of the marked region visualizes the respective probability that the target position is at this point.

In one step S200, the application is simulated on the basis of the ascertained stochastic value, i.e. with a stochastic target position, on the computer 3 or in the cloud 4.

A control agent is trained by means of reinforcement learning.

In one step S300, it is checked whether the control agent has already been sufficiently trained. If this is not the case (S300: “N”), the random number generator 3a generates a new stochastic target position with which a further simulation is carried out.

If the control agent has been sufficiently trained (S300: “Y”), the controller 2 of the robot 1 is configured on the basis of the trained control agent (S400).

In addition, a classification agent is trained using the simulations carried out, for example machine-learned anomaly or error detection (S500), i.e. the simulations carried out when training the control agent are used.

The real application is then carried out using the robot 1 with the controller configured in step S400 (S600) and thereby or subsequently classified by means of anomaly or error detection (S700). The configured control can thereby be further trained.

Although embodiments have been explained in the preceding description, it is noted that a large number of modifications are possible. It is also noted that the embodiments are merely examples that are not intended to restrict the scope of protection, the applications and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be

1-24. (canceled)

25. A method for carrying out an application using at least one robot, the method comprising:
repeating multiple times:
ascertaining a stochastic value of at least one robot parameter and/or at least one environmental model parameter [associated with the application?], and
carrying out a simulation of the application on the basis of the ascertained stochastic value; then
training at least one control agent and/or at least one classification agent using the simulations by machine learning;
performing the application using the robot; and
at least one of:
configuring a controller of the robot, by which the application is carried out wholly or in part, on the basis of the trained control agent, or
classifying the application using the trained classification agent.

26. The method of claim 25, wherein at least one of:
ascertaining the stochastic value comprises at least one of ascertaining on the basis of a specified stochastic parameter model or ascertaining using at least one random generator;
the simulation of the application is a multi-stage simulation;
training using the simulations by machine learning comprises:
training at least one of a first control agent or a first classification agent by first stages of the simulations, and
training at least one additional control agent and/or additional classification agent by additional stages of the simulations;
configuring the controller comprises configuring on the basis of the trained control agents; or
classifying the application comprises using a plurality of trained classification agents.

27. The method of claim 25, wherein at least one of:
the at least one control agent and/or the at least one classification agent comprises at least one of machine-learned anomaly detection, machine-learned error detection, or at least one artificial neural network; or
the at least one control agent and/or the at least one classification agent is at least one of trained via reinforcement learning or trained using the robot.

28. The method of claim 27, wherein configuring the controller of the robot comprises configuring the controller on the basis of at least one of structure or weights of the trained neural network.

29. The method of claim 25, wherein at least one of:
classifying the application with the at least one classification agent comprises at least one of classifying on the basis of at least one time segment, classifying while the application is being carried out, or classifying after the application has been carried out; or
training the at least one control agent and/or the at least one classification agent comprises training on the basis of at least one state variable that is not measured when the application is carried out.

30. The method of claim 25, wherein at least one of:
the robot parameter comprises a start pose and at least one of:
at least one intermediate pose,
a target pose of the application,
a force parameter of at least one of a robot-internal or external force acting at least temporarily on the robot, or
a kinematic robot structure parameter;
the environmental model parameter comprises a kinematic environmental parameter; or
at least one of the robot parameter or the environmental model parameter is ascertained using robot-assisted parameter identification.

31. The method of claim 30, further comprising checking whether at least one of the start pose, the intermediate pose, or the target pose can be reached with the robot.

32. The method of claim 26, wherein at least one of:
the stochastic parameter model is at least one of:
specified on the basis of the application,
specified on the basis of user input, or
visualized in an image of the application by a marked region; or
at least one of the robot parameter or the environmental model parameter is at least one of:
specified on the basis of the application,
specified on the basis of user input, or
visualized in an image of the application by a marked region.

33. The method of claim 25, further comprising at least one of:
testing at least one of the configured controller of the robot, the machine-learned anomaly detection, or the error detection using at least one additional simulation; or
further training at least one of the configured controller of the robot, the machine-learned anomaly detection, or the error detection using the robot.

34. The method of claim 33, wherein testing using at least one additional simulation is based on an automated or user specification of a value of at least one robot parameter and/or at least one environmental model parameter

35. The method of claim 26, wherein the stochastic parameter model is specified by machine learning.

36. A system for carrying out an application using at least one robot, the system comprising:
means for repeating multiple times steps of:
ascertaining a stochastic value of at least one robot parameter and/or at least one environmental model parameter associated with the application, and
carrying out a simulation of the application on the basis of the ascertained stochastic value;
means for training at least one control agent and/or at least one classification agent using the simulations by machine learning;
means for performing the application using the robot; and
means for at least one of:
configuring a controller of the robot, by which the application is carried out wholly or in part, on the basis of the trained control agent, or
classifying the application using the trained classification agent.

37. A method for configuring a controller of a robot for carrying out a specified task, the method comprising:
recording at least one robot parameter and at least one environmental model parameter;
training an agent using at least one simulation based on the recorded robot parameters and environmental model parameters by machine learning on the basis of a specified cost function; and
configuring the controller of the robot based on the trained agent.

38. The method according to claim 37, wherein the specified task comprises at least one motion of the robot, in particular at least one scheduled environmental contact of the robot.

39. The method of claim 37, wherein at least one of:
the robot parameter comprises at least one of:
a kinematic, in particular dynamic, robot parameter,
a load model parameter,
a current robot pose, or
a current robot operating time; or
the environmental model parameter at least one of:
comprises at least one of a CAD model parameter or a robot positioning in the environmental model, or
is ascertained using at least one optical sensor.

40. The method of claim 37, wherein at least one of:
the agent comprises an artificial neural network; or
the agent is trained by reinforcement learning.

41. The method of claim 37, further comprising:
further training the configured controller of the robot by machine learning, in particular reinforcement learning, using the robot.

42. The method of claim 37, wherein at least one of:
at least one of the recording, training, or configuring steps comprises user input support by a software assistant, in particular a user interface; or
at least one of the robot parameters or the environmental model parameters are stored in at least one of an asset administration shell or a data cloud.

43. A system for configuring a controller of a robot for carrying out a specified task, the system comprising means for:
recording at least one robot parameter and at least one environmental model parameter;
training an agent using at least one simulation based on the recorded robot parameters and environmental model parameters by machine learning on the basis of a specified cost function; and
configuring the controller of the robot based on the trained agent.
